(19) United States
(12) Patent Application Publication
(10) Pub. No.: US 2008/0187782 A1
(43) Pub. Date: Aug. 7, 2008

(54) MAGNETIC RECORDING MEDIA AND HARD DISK DRIVE APPARATUS HAVING THE SAME

(75) Inventors: Chang-Hwan LEE, Seoul (KR); Sang Hyub LEE, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/023,240

(22) Filed: Jan. 31, 2008

(30) Foreign Application Priority Data
Feb. 6, 2007 (KR) 2007-11939

(51) Int. Cl. G11B 5/706; B05D 5/12; G11B 5/33

(52) U.S. Cl. 428/814; 428/846; 428/810; 427/128

(57) ABSTRACT

A perpendicular magnetic recording medium includes a substrate forming a base, a magnetic layer deposited on a surface of the substrate in a direction along a thickness of the substrate, and an overcoat deposited on the magnetic layer in the direction along the thickness of the substrate to protect the magnetic layer, and having a texture formed partially indented from a surface and textured to have a predetermined surface roughness. The hard disk drive apparatus includes a magnetic head and the perpendicular magnetic recording medium where data is recorded and stored using the magnetic head.

### CROSS-REFERENCE TO RELATED APPLICATIONS

This application claims priority under 35 U.S.C § 119(a) from Korean Patent Application No. 10-2007-0011939, filed on Feb. 6, 2007, in the Korean Intellectual Property Office, the disclosure of which is incorporated herein in its entirety by reference.

### BACKGROUND OF THE INVENTION

1. Field of the Invention

The present general inventive concept relates to perpendicular magnetic recording media and a hard disk drive apparatus having the same, and more particularly, to perpendicular magnetic recording media that can make a structure of a magnetic recording medium in a desired shape and prevent deterioration of a magnetic performance while securing a sufficient surface roughness required for the magnetic recording medium so that various problems such as a head disk interference (HDI) can be prevented, and a hard disk drive apparatus having the same.

2. Description of the Related Art

Magnetic recording media used for hard disk drives includes longitudinal magnetic recording (LMR) and perpendicular magnetic recording (PMR). The LMR is to perform magnetic recording by forming recording bits in a direction parallel to a surface of a magnetic recording medium. The PMR is to perform magnetic recording by forming recording bits in a direction perpendicular to the surface of a magnetic recording medium having vertical magnetic anisotrophy. Since the PMR has higher magnetostatic energy and lower demagnetizing energy than the LMR, the PMR is advantageous in a high recording density.

The magnetic recording media are manufactured by applying a sputtering process to media of a soft underlayer, an interlayer, a magnetic layer, and an overcoat with respect to a substrate. The sputtering process is one of the methods for manufacturing semiconductor wafers.

In the conventional LMR that has been widely used, texture is formed on the substrate through a texturing process prior to the sputtering process, that is, the above-mentioned media are sequentially sputtering processed on and above the substrate where the texture is formed. The forming of a texture on the substrate prior to the sputtering process helps form a magnetic domain so that a magnetic performance is improved and a roughness with respect to the magnetic recording media is maintained. Thus, the interference problem can be solved by reducing friction between a magnetic head or a read/write head and the magnetic recording media.

For reference, for a magnetic transition metal or alloy, it is known that a direction of magnetization (hereinafter, referred to as the easy axis direction) is determined by the crystal structure of the metal itself without separately applying an electric field or magnetic field from the outside. Typically, in a magnetic layer formed of a Co alloy having a hexagonal prism crystal structure, the easy axis direction is the axis of the hexagonal prism. In the case of the LMR, since the axis of the hexagonal prism is a direction along the surface of the magnetic recording medium, forming a texture on the substrate is advantageous in the improvement of a magnetic performance due to the effect of the texture.

In contrast, for the PMR, when the texturing process or a polish process similar to the texturing process is performed to the substrate as in the LMR, since the structure of the magnetic recording medium may not have a desired shape, it is common that the texture is not formed on the substrate in the PMR.

When the texture is not formed on the substrate, the structure of the magnetic recording medium can be formed as desired and further the magnetic performance can be improved. Accordingly, in the case of the PMR in which the hexagonal prism crystal structure of a Co alloy is grown perpendicularly to the surface of the magnetic recording medium, since the easy axis direction is formed vertically, when the texture is formed on the substrate, the magnetic performance can be deteriorated.

However, in the PMR where the texture is not formed on the substrate, since a sufficient surface roughness with respect to the magnetic recording medium cannot be obtained, a head disk interface (HDI) problem that a physical shock is generated between the magnetic head and the magnetic recording medium, that is, a disk of a hard disk drive, during the operation of the hard disk drive can be generated. In particular, for a micro drive that rotates the magnetic recording medium at a low rpm, since a low rotational force may considerably affect the HDI, a solution for the problem is needed.

### SUMMARY OF THE INVENTION

The present general inventive concept provides perpendicular magnetic recording media that can make a structure of a magnetic recording medium in a desired shape and prevent deterioration of a magnetic performance while securing a sufficient surface roughness required for the magnetic recording medium so that various problems such as a head disk interference (HDI) can be prevented, and a hard disk drive apparatus having the same.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a perpendicular magnetic recording medium comprising a substrate forming a base, a magnetic layer deposited on a surface of the substrate in a direction along a thickness of the substrate, and an overcoat deposited on the magnetic layer in the direction along the thickness of the substrate to protect the magnetic layer, and having a texture formed partially indented from a surface and textured to have a predetermined surface roughness.

The perpendicular magnetic recording medium may further include a soft underlayer and an interlayer sequentially formed in the direction along the thickness of the substrate between the substrate and the magnetic layer.

The soft underlayer, the interlayer, the magnetic layer, and the overcoat may be formed by performing a sputtering process with respect to the substrate, and the texture formed on the overcoat may be formed by a separate post-process after the sputtering process.

The post-process may be any one selected from a texturing process, a chemical etching process, and a lithography process.

A surface of the substrate may be a substantially smooth plane.

The texture may have a roughness average per unit area in a range between 0.1 Å-10 Å.

The overcoat may be formed of a diamond like carbon (DLC) material.

The perpendicular magnetic recording medium may further include a lube coated on the overcoat to prevent abrasion of a surface of the overcoat.

The foregoing and/or other aspects and utilities of the present general inventive concept may also be achieved by providing a hard disk drive apparatus including a magnetic head and a perpendicular magnetic recording medium where data is recorded and stored using the magnetic head, the perpendicular magnetic recording medium includes a substrate forming a base, a magnetic layer deposited on a surface of the substrate in a direction along a thickness of the substrate, and an overcoat deposited on the magnetic layer in the direction along the thickness of the substrate, protecting the magnetic layer, and having a texture formed partially indented from a surface and textured to have a predetermined surface roughness.

The hard disk drive apparatus may further include a soft underlayer and an interlayer sequentially formed in the direction along the thickness of the substrate between the substrate and the magnetic layer.

The soft underlayer, the interlayer, the magnetic layer, and the overcoat may be formed by performing a sputtering process with respect to the substrate, and the texture formed on the overcoat may be formed by a separate post-process after the sputtering process.

The post-process may be any one selected from a texturing process, a chemical etching process, and a lithography process.

A surface of the substrate may be a substantially smooth plane.

The texture may have a roughness average per unit area in a range between 0.1 Å-10 Å.

The overcoat may be formed of a diamond like carbon (DLC) material.

The hard disk drive apparatus may further include a lube coated on the overcoat to prevent abrasion of a surface of the overcoat.

The magnetic recording medium may be applied to a micro drive having a rotation speed in a range between 3,600-5,400 rpm.

The magnetic recording medium may have a diameter in a range of 0.7-1.0 inches.

The foregoing and/or other aspects and utilities of the general inventive concept may also be achieved by providing a perpendicular magnetic recording medium including a substrate layer having a substantially smooth upper surface, an overcoat layer having a textured upper surface with a predetermined roughness and a magnetic layer interposed between the substrate layer and the overcoat layer, wherein the substantially smooth upper surface of the substrate layer faces the magnetic layer and the textured upper surface of the overcoat layer does not face the magnetic layer.

The foregoing and/or other aspects and utilities of the general inventive concept may also be achieved by providing a method of forming a perpendicular magnetic recording medium, the method including forming a substrate layer having a substantially smooth upper surface, forming an overcoat layer having a textured upper surface with a predetermined roughness and forming a magnetic layer interposed between the substrate layer and the overcoat layer so that the magnetic layer faces the substantially smooth upper surface of the substrate layer and the magnetic layer does not face the textured upper surface of the overcoat layer.

The foregoing and/or other aspects and utilities of the general inventive concept may also be achieved by providing a disk drive apparatus including a magnetic head and a perpendicular magnetic recording medium including a substrate layer having a substantially smooth upper surface, an overcoat layer having a textured upper surface with a predetermined roughness and a magnetic layer interposed between the substrate layer and the overcoat layer, wherein the substantially smooth upper surface of the substrate layer faces the magnetic layer and the textured upper surface of the overcoat layer does not face the magnetic layer.

The foregoing and/or other aspects and utilities of the general inventive concept may also be achieved by providing a perpendicular magnetic recording medium including a substrate layer having a substantially smooth upper surface, an overcoat layer having a textured upper surface with a predetermined roughness, an interlayer disposed between the overcoat layer and the substrate layer, a magnetic layer disposed between the interlayer and the overcoat layer and a soft underlayer disposed between the interlayer and the substrate layer.

### BRIEF DESCRIPTION OF THE DRAWINGS

The above and/or other aspects and utilities of the present general inventive concept will become apparent and more readily appreciated from the following detailed description, taken in conjunction with the accompanying drawings of which:

FIG. 1 is an exploded perspective view illustrating a hard disk drive apparatus according to an embodiment of the present general inventive concept;

FIG. 2 is a plan view illustrating a magnetic recording medium of FIG. 1;

FIG. 3 illustrates a structure of the magnetic recording medium of FIG. 2;

FIG. 4 is a plot illustrating a relationship among the Ra, Δθ50, and the SNR according to a recording density; and

FIG. 5 is a graph illustrating an X-ray characteristic peak of a magnetic layer.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

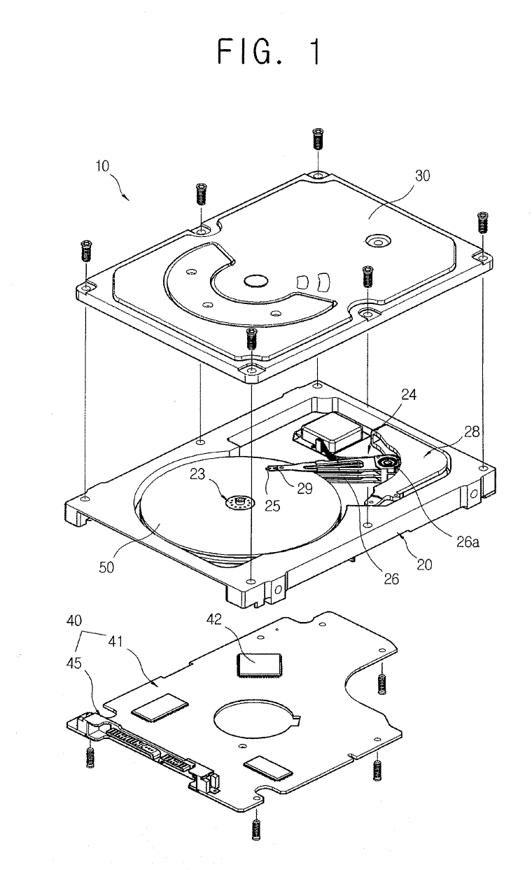

FIG. 1 is an exploded perspective view illustrating a hard disk drive apparatus according to an embodiment of the present general inventive concept. Referring to FIG. 1, a hard disk drive apparatus 10 according to the present embodiment includes at least one magnetic recording medium 50 to record and store data, a spindle motor 23 to rotate the magnetic recording medium 50, a head stack assembly (HSA) moving toward the magnetic recording medium 50, a base 20 on which these units are assembled, a cover 30 to cover an upper open portion of the base 20, and a printed circuit board assembly (PCBA) 40 coupled to a lower portion of the base 20.

For reference, the magnetic recording medium 50 in the hard disk drive apparatus 10 is referred to as a disk. At least one or more magnetic recording medium 50 can be provided according to a capacity of the hard disk drive apparatus 10. When two or more magnetic recording media 50 are provided, a separate spacer is interposed between the two magnetic recording media 50.

Also, in the hard disk drive apparatus 10 according to the present embodiment, the magnetic recording medium 50 can be a micro drive having a rotational speed in a range of 3,600-5,400 rpm. Accordingly, the magnetic recording medium 50 can have a diameter of 0.7-1.0 inch. However, the scope of the present general inventive concept is not limited to the above descriptions. A structure and characteristics of the magnetic recording medium 50 will be described later.

The HSA 24 includes a magnetic head 25 recording data on the magnetic recording medium 50 or reproducing the recorded data and an actuator 26 making the magnetic head 25 fly and access the data on the magnetic recording medium 50. The magnetic head 25 is disposed at a leading end of a head gimbal 29 extending from the actuator 26 and lifted by air flow on the surface of the magnetic recording medium 50 as the magnetic recording medium 50 rotates at a high speed so as to fly with a fine gap from the surface of the magnetic recording medium 50.

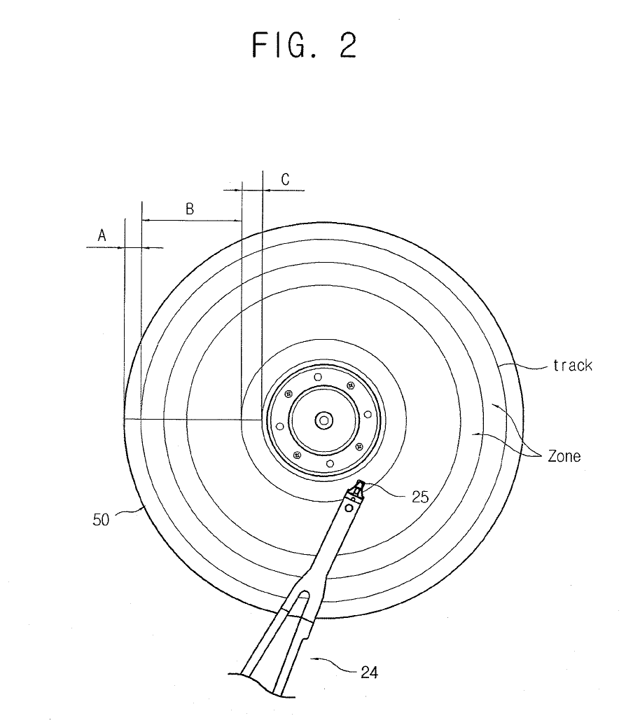

The actuator 26 is capable of rotating across the magnetic recoding medium 50 around a pivot shaft 26a. That is, a voice coil motor (VCM) 28 disposed at one end of the actuator 26 actuates the magnetic head 25 disposed at the opposite end of the actuator 26 to radially move left and right above the magnetic recording medium 50 and read and write data with respect to tracks on the magnetic recording medium 50 (FIG. 2).

Although it is not illustrated in the drawings, a latch (not illustrated) elastically supporting the actuator 26 to prevent the actuator 26 from arbitrarily moving when the magnetic head 25 is parked in a parking area C (FIG. 2) of the magnetic recording medium 50 is provided at a lower portion of the VCM 28. When a separate ramp is provided unlike the drawings, the magnetic head 25 is parked on the ramp. Accordingly, the parking area is disposed away from the magnetic recording medium 50.

The PCBA 40 includes a printed circuit board (PCB) 41 where a plurality of circuit units are mounted and a plug 45 coupled to a side of the PCB 41. A controller 42 to control various functions of the hard disk drive apparatus 10 is provided on a surface of the PCB 41 as a plurality of circuit units. A memory (not illustrated) to store various data or tables is provided around the controller 42.

FIG. 2 is a plan view illustrating a magnetic recording medium of FIG. 1. Referring to FIG. 2, the magnetic recording medium 50 includes a system zone A, a user data zone B, and a parking zone C. The system zone A is referred to as a maintenance zone and a place where various system information and information about maintenance and repair of the hard disk drive apparatus 10 are stored, and prohibits access by a general user.

The parking zone C is used when the magnetic head 25 is parked on the magnetic recording medium 50. A method of parking the magnetic head 25 in the parking zone C when a power supply to the hard disk drive apparatus 10 is stopped is referred to as a contact start stop (CSS) method. When the magnetic head 25 is parked on a ramp (not illustrated), the parking zone C is disposed away from the magnetic recording medium 50.

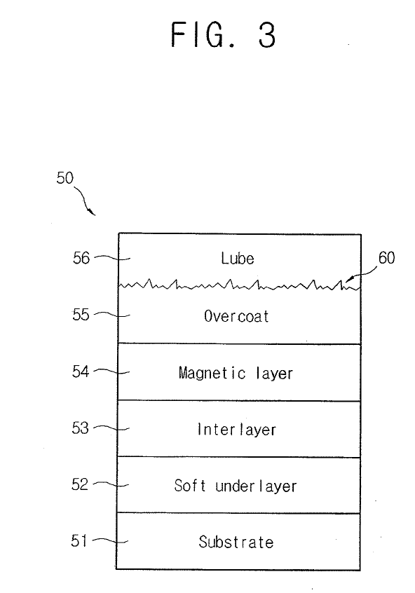

The user data zone B located between the system zone A and the parking zone C is a place where user data is stored. The user data zone B occupies most of the surface of the magnetic recording medium 50. Thus, data is recorded on the tracks that are concentric circles formed in the user data zone B. To facilitate storing and seeking of data in a regular manner, the track of the magnetic recording medium 50 is divided into a plurality of blocks or sectors. The positional information of the sectors is indicated by the track or a cylinder, the magnetic head 25, and an intrinsic identifier referred to as a sector number. Also, the magnetic recording medium 50 is managed by being divided into several sections or zones from the outer circumference to the inner circumference. The magnetic recording medium 10 configured as described above includes a plurality of layers (media) in a vertical direction that will be described with reference to FIGS. 3 through 5.

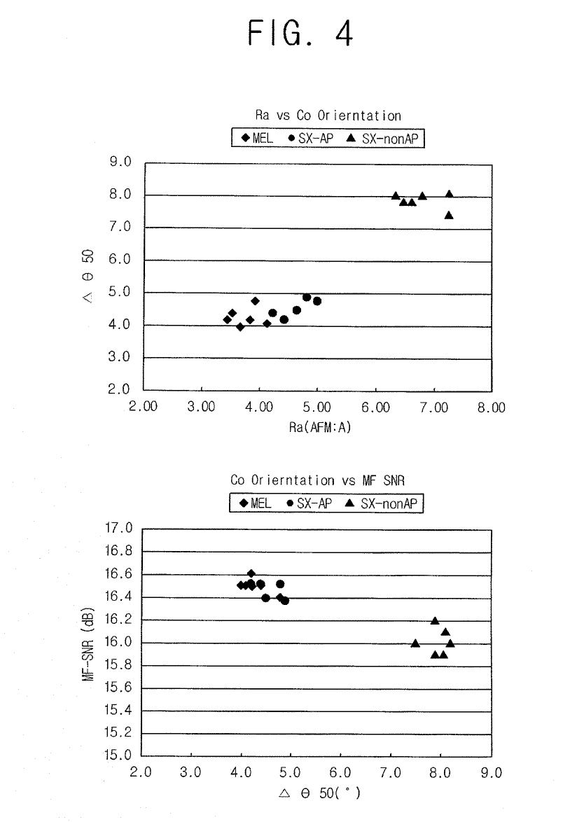

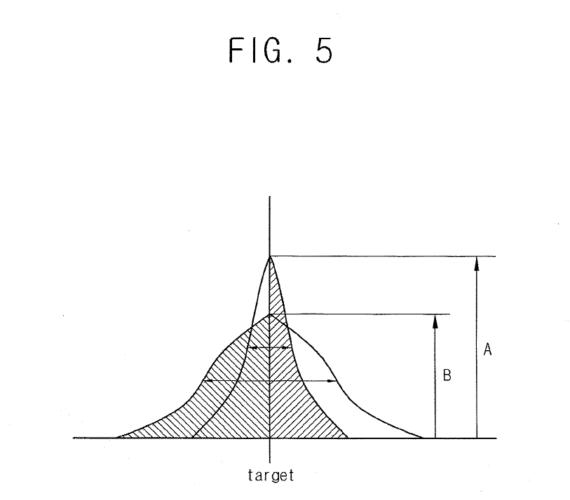

FIG. 3 illustrates a structure of the magnetic recording medium of FIG. 2. FIG. 4 is a plot illustrating a relationship among a roughness average per unit area (Ra), Δθ50, and the SNR according to a recording density. FIG. 5 is a graph illustrating an X-ray characteristic peak of a magnetic layer.

As illustrated in FIG. 3, the magnetic recording medium 50 includes a plurality of layers (media) in a vertical direction parallel to a rotation axis of the magnetic recording medium. A substrate 51 is provided at a bottom of the magnetic recording medium 50. In a direction along a thickness of the substrate 51, a soft underlayer 52, an interlayer 53, a magnetic layer, and an overcoat 55 by a sputtering process. A lube 56 can further be provided on an upper surface of the overcoat 55. As described above, since the sputtering process is one of the conventional methods of manufacturing a semiconductor wafer, a detailed description thereof will be omitted herein. The lube 56 is a lubricant applied to a surface of the overcoat 55 or the texture 60. A silicone lube may be used with lube 60. A conventional lubricant may be used with lube 56.

The soft underlayer 52 provides a path for a magnetic field so that the magnetic layer 54 can be smoothly magnetized in a vertical direction. The interlayer 53 facilitates the formation of the magnetic layer 54 on the soft under layer 52. The magnetic layer 54 is magnetized in the vertical direction to store data. The overcoat 55 protects the magnetic layer 54 and the lube 56 protects the surface of the magnetic recording medium 10 from being abraded. Since the scope of the present general inventive concept is not limited to the above structure of the magnetic recording medium 10 of FIG. 3, another layer may be further included or any of the above layers may be excluded. The substrate 51 forms a base of the magnetic recording medium 10, is formed of hard glass or a metal material, and forms most of the thickness of the magnetic recording medium 10.

As described above, in the LMR, a texture (not illustrated) is formed through a texturing process on the substrate 51 prior to the sputtering process. However, in the magnetic recording medium 50 of the PMR according to the present embodiment, when the texture is formed on the substrate 51, the structure of the magnetic recording medium 50 substantially may not have a desire shape as illustrated in FIG. 3 and further the magnetic performance can be deteriorated.

Accordingly, in the present embodiment, the texture is not formed on the substrate 51 to solve the above problems. That is, the surface of the substrate 51 substantially forms a smooth plane. Accordingly, the structure of the magnetic recording medium 50 can substantially have a desired shape as illustrated in FIG. 3. Also, since the texture is not formed on the substrate 51, the deterioration of the magnetic performance can be prevented.

However, as described above, when a texture 60 of FIG. 3 is not formed at all in the magnetic recording medium 50 in the PMR, a sufficient roughness to the magnetic recording medium 50 cannot be obtained. Thus, a head disk interface (HDI) problem that is a physical shock generated between the magnetic head 25 and the magnetic recording medium 50 can be generated during operation of the hard disk drive apparatus 10. In particular, in a micro drive that rotates the magnetic recording medium 50 at a low rotational speed, that is, a speed between 3,600-5,400 rpm, the low rotational speed may cause the HDI to occur more frequently.

Also, when the texture is formed on the substrate 51, since a flying height (FH) of the magnetic head 25 flying over the surface of the magnetic recording medium 50 can usually be designed greater than a typical reference height, various derivative problems may be generated accordingly. Accordingly, in the present embodiment, the texture 60 is formed on the overcoat 55 forming an outermost layer of the magnetic recording medium 50. Thus, a sufficient surface roughness required for the magnetic recording medium 50 can be obtained. The overcoat 55 where the texture 60 is formed can be formed of a diamond like carbon (DLC) material. The texture 60 and/or the overcoat 55 may have a surface roughness different from other layers of the magnetic recording medium 50. The texture 60 and/or the overcoat 55 may also have a surface-shape different from other layers. The surface roughness and/or shape of the texture 60 and/or the overcoat 55 may be formed in a rotation direction, a radial direction, and/or the vertical direction.

The texture 60 can be formed on the overcoat 55 by a typical texturing process. The texturing process is to grind the surface of the overcoat 55 using a separate rough grinder. Thus, the texture 60 can be formed on the overcoat 55 in the above process. However, since the scope of the present general inventive concept is not limited thereto, the texture 60 can be formed in any semiconductor processes including a chemical etching process or a lithography process.

The texture 60 that can be formed in the above process is textured in a circumferential direction of the magnetic recording medium 50. The texture 60 can be formed in a radial direction of the magnetic recording medium 50. However, when the texture 60 is formed in the radial direction, the magnetic performance is lowered than that formed in the circumferential direction so that the data capacity of the track of FIG. 2 may be decreased. Thus, in an embodiment of the present general inventive concept the texture 60 is formed in the circumferential direction of the magnetic recording medium 50. Since the scope of the present general inventive concept is not limited thereto, the texture 60 can be formed in other directions in addition to the circumferential direction and the radial direction.

The shape of the texture 60 can be a variety of shapes such as a simply uneven shape or a triangular saw-teethed shape. In addition, even when the texture 60 has a simply uneven shape or a triangular saw-teethed shape, the structure can be regular or partially irregular. In the present embodiment, the latter one is illustrated in FIG. 3. Also, in the present embodiment, the texture 60 has a roughness average per unit area (RA) between 0.1 Å-10 Å.

For reference, the RA of the magnetic recording medium 50 is related to the FH of the magnetic head 25. For example, when the Ra of the magnetic recording medium 50 is relatively large, the deterioration of the flying ability of the magnetic head 25 can be prevented. This is because a larger air flow is generated during the rotation of the magnetic recording medium 50 when the Ra is large.

However, when the Ra is large, as in the present embodiment, a signal-to-noise ratio (SNR) according to the recording density is deteriorated in the magnetic recording medium 50 adopting the PMR. That is, as illustrated in FIG. 4, as the Ra decreases, the verticality of crystals of the magnetic layer 54 is improved and a Δθ50 value decreases. As the Δθ50 value decreases, the distribution is dense and the SNR is improved. In contrast, as the Ra increases, the verticality of crystals is deteriorated and the Δθ50 value increases. As the Δθ50 value increases, the distribution is wide and the SNR is deteriorated.

As illustrated in FIG. 5, the Δθ50 indicates a full width of half maximum value of a portion corresponding to 50% of the X-ray characteristic peak distribution when an X-ray diffraction (XRD) is measured to analyze the characteristic of the crystal structure of the magnetic layer 54, and is normally recorded in a unit of no dimension. In FIG. 5, a graph A illustrates when the verticality is superior while a graph B illustrates when the verticality is relatively inferior.

Thus, although it is acceptable that the texture 60 has an Ra in a range between 0.1 Å-10 Å, the texture 60 should have the minimum Ra only if it meets a condition required for the magnetic recording medium 50. However, the scope of the present general inventive concept is not limited to the above numbers.

A method of manufacturing the PMR medium configured as described above and an operation of a hard disk drive apparatus 10 manufactured in the above method are described. First, the substrate 51 is prepared and the surface of the substrate 51 is processed to form a smooth plane. The soft underlayer 52, the interlayer 53, the magnetic layer 54 and the overcoat 55 are sequentially formed by a sputtering process in a direction along the thickness of the substrate 51 using the substrate 51 as a base. Since the surface of the substrate 51 is substantially smooth, the structure of the magnetic recording medium 50 as illustrated in FIG. 3 can be made into a desired shape. Since the texture 60 is not formed on the substrate 51, the deterioration of the magnetic performance can be prevented.

When the overcoat 55 is formed, as described above, the texture 60 is formed in any one selected from the processing methods of the texturing process, a chemical etching process, and a lithography process. The present state is cleaned and the lube 56 is further formed on the upper surface of the overcoat 55. The magnetic recording medium 50 is assembled to the hard disk drive apparatus 10. A gliding operation of the magnetic head 25 to the magnetic recording medium 50 is tested. A reliability test is also performed.

When the power is applied to the hard disk drive apparatus 10 having the magnetic recording medium 50 manufactured in the above method, the spindle motor 23 rotates the magnetic recording medium 50. Accordingly, the magnetic head 25 flies over the surface of the magnetic recording medium 50 to read or write data with respect to the magnetic recording medium 50. According to the operation of the hard disk drive apparatus 10, since a sufficient surface roughness required for the magnetic recording medium 50 can be secured, various problems such as the HDI can be prevented.

When the power to the hard disk drive apparatus 10 is cut off and the magnetic recording medium 50 stops the rotation, the actuator 26 rotates the magnetic head 25 in the opposite direction around the pivot shaft 26a so that the magnetic head 25 flying over the upper surface of the magnetic recording medium 50 can be parked.

According to various embodiments of the present general inventive concept, the structure of the magnetic recording medium 50 can be made into a desired shape and the deterioration of the magnetic performance can be prevented. Accordingly, a sufficient surface roughness required for the magnetic recording medium 50 is secured so that various problems such as the HDI can be prevented.

Although the above embodiment focuses on the 1 inch or less micro drive, the technical concept of the present general inventive concept can be applied to 2.5 inch or more hard disk drive apparatus. Although, in the above embodiment, the magnetic recording medium is used for the hard disk drive apparatus, the technical concept of the present general inventive concept can also be applied to magnetic recording media used for apparatus other than hard disk drive apparatus.

Although a few embodiments of the present general inventive concept have been illustrated and described, the present general inventive concept is not limited to the described embodiments. Instead, it would be appreciated by those skilled in the art that changes may be made to these embodiments without departing from the principles and spirit of the general inventive concept, the scope of which is defined by the claims and their equivalents.

As described above, according to the present general inventive concept, the structure of the magnetic recording medium is made into a desired shape and also the deterioration of the magnetic performance is prevented. Also, since a sufficient surface roughness required for the magnetic recording medium is secured, various problems such as the HDI can be prevented.

What is claimed is:

1. A perpendicular magnetic recording medium, comprising:
a substrate forming a base;
a magnetic layer deposited on a surface of the substrate in a direction along a thickness of the substrate; and
an overcoat deposited on the magnetic layer in the direction along the thickness of the substrate, to protect the magnetic layer, and having a texture formed partially indented from a surface and textured to have a predetermined surface roughness.

2. The perpendicular magnetic recording medium of claim 1, further comprising:
a soft underlayer and an interlayer sequentially formed in the direction along the thickness of the substrate between the substrate and the magnetic layer.

3. The perpendicular magnetic recording medium of claim 2, wherein the soft underlayer, the interlayer, the magnetic layer, and the overcoat are formed by performing a sputtering process with respect to the substrate, and the texture formed on the overcoat is formed by a separate post-process after the sputtering process.

4. The perpendicular magnetic recording medium of claim 3, wherein the post-process is any one selected from a texturing process, a chemical etching process, and a lithography process.

5. The perpendicular magnetic recording medium of claim 1, wherein a surface of the substrate is a substantially smooth plane.

6. The perpendicular magnetic recording medium of claim 1, wherein the texture has a roughness average per unit area in a range between 0.1 Å-10 Å.

7. The perpendicular magnetic recording medium of claim 1, wherein the overcoat is formed of a diamond like carbon (DLC) material.

8. The perpendicular magnetic recording medium of claim 1, further comprising:
a lube coated on the overcoat to prevent abrasion of a surface of the overcoat.

9. A hard disk drive apparatus, comprising:
a magnetic head; and
a perpendicular magnetic recording medium where data is recorded and stored using the magnetic head, the perpendicular magnetic recording medium comprises:
a substrate forming a base;
a magnetic layer deposited on a surface of the substrate in a direction along a thickness of the substrate; and
an overcoat deposited on the magnetic layer in the direction along the thickness of the substrate, protecting the magnetic layer, and having a texture formed partially indented from a surface and textured to have a predetermined surface roughness.

10. The hard disk drive apparatus of claim 9, further comprising:
a soft underlayer and an interlayer sequentially formed in the direction along the thickness of the substrate between the substrate and the magnetic layer.

11. The hard disk drive apparatus of claim 10, wherein the soft underlayer, the interlayer, the magnetic layer, and the overcoat are formed by performing a sputtering process with respect to the substrate, and the texture formed on the overcoat is formed by a separate post-process after the sputtering process.

12. The hard disk drive apparatus of claim 11, wherein the post-process is any one selected from a texturing process, a chemical etching process, and a lithography process.

13. The hard disk drive apparatus of claim 9, wherein a surface of the substrate is a substantially smooth plane.

14. The hard disk drive apparatus of claim 9, wherein the texture has a roughness average per unit area in a range between 0.1 Å-10 Å.

15. The hard disk drive apparatus of claim 9, wherein the overcoat is formed of a diamond like carbon (DLC) material.

16. The hard disk drive apparatus of claim 9, further comprising:
a lube coated on the overcoat to prevent abrasion of a surface of the overcoat.

17. The hard disk drive apparatus of claim 9, wherein the magnetic recording medium is applied to a micro drive having a rotation speed in a range between 3,600-5,400 rpm.

18. The hard disk drive apparatus of claim 9, wherein the magnetic recording medium has a diameter in a range of 0.7-1.0 inches.

19. A perpendicular magnetic recording medium, comprising:
a substrate layer having a substantially smooth upper surface;
an overcoat layer having a textured upper surface with a predetermined roughness; and
a magnetic layer interposed between the substrate layer and the overcoat layer;
wherein the substantially smooth upper surface of the substrate layer faces the magnetic layer and the textured upper surface of the overcoat layer does not face the magnetic layer.

20. A method of forming a perpendicular magnetic recording medium, the method comprising:
forming a substrate layer having a substantially smooth upper surface;
forming an overcoat layer having a textured upper surface with a predetermined roughness; and
forming a magnetic layer interposed between the substrate layer and the overcoat layer so that the magnetic layer faces the substantially smooth upper surface of the substrate layer and the magnetic layer does not face the textured upper surface of the overcoat layer.

21. A hard disk drive apparatus, comprising:
a magnetic head; and
a perpendicular magnetic recording medium, comprising:
a substrate layer having a substantially smooth upper surface;
an overcoat layer having a textured upper surface with a predetermined roughness; and
a magnetic layer interposed between the substrate layer and the overcoat layer;
wherein the substantially smooth upper surface of the substrate layer faces the magnetic layer and the textured upper surface of the overcoat layer does not face the magnetic layer.

22. A perpendicular magnetic recording medium, comprising:
a substrate layer having a substantially smooth upper surface;
an overcoat layer having a textured upper surface with a predetermined roughness;
an interlayer disposed between the overcoat layer and the substrate layer;
a magnetic layer disposed between the interlayer and the overcoat layer; and
a soft underlayer disposed between the interlayer and the substrate layer.
